(19) United States
(12) Patent Application Publication
(10) Pub. No.: US 2009/0149968 A1
(43) Pub. Date: Jun. 11, 2009

(54) CONTROL APPARATUS, CONTROL METHOD, AND COMPUTER PROGRAM PRODUCT

(75) Inventor: Takaharu HOSOI, Suntou-gun (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/351,286

(22) Filed: Jan. 9, 2009

Related U.S. Application Data
(63) Continuation of application No. PCT/JP2007/063427, filed on Jul. 12, 2006.

(30) Foreign Application Priority Data
Jul. 12, 2006 (JP) 2006-192092

(51) Int. Cl. G05B 11/01

(52) U.S. Cl. 700/21

(57) ABSTRACT

A control apparatus for controlling procedure of a controlled apparatus includes an update controller that determines, when the software is updated, whether a post-update software is to be selected based on an actual operation result of operating the controlled apparatus using the post-update software. The update controller puts the pre-update software back in use if the operation result is not within a predetermined acceptable range.

### CROSS-REFERENCE TO RELATED APPLICATIONS

This application is a continuation of PCT international application Ser. No. PCT/JP2007/063427 filed on Jul. 5, 2007 which designates the United States, incorporated herein by reference, and which claims the benefit of priority from Japanese Patent Application No. 2006-192092, filed on Jul. 12, 2006, incorporated herein by reference.

### BACKGROUND OF THE INVENTION

1. Field of the Invention

The present invention relates to a control apparatus, a control method, and a computer program product for controlling operations of a controlled apparatus with use of software.

2. Description of the Related Art

Conventionally, as an apparatus which automatically analyzes a specimen such as blood and bodily fluid, there has been known an analyzer which adds the specimen to a reaction vessel into which a reagent is dispensed, and optically detects reaction caused on the specimen and the reagent in the reaction vessel. In the analyzer, a measuring system which measures the reaction in the reaction vessel is connected with a computer system, and the computer system uses various software for each process of the analyzer, controls driving of the measuring system, and performs analysis of a result of the measurement of the measuring system. In the computer system, various software being used is updated, e.g., upgraded in version via a network, or via a storage medium storing update software (e.g., see Japanese Patent Application Laid-Open No. H11-95989).

### SUMMARY OF THE INVENTION

A control apparatus according to an aspect of the present invention is for controlling procedure of a controlled apparatus, and includes an update controller that determines, when the software is updated, whether a post-update software is to be selected based on an actual operation result of operating the controlled apparatus using the post-update software. The update controller also puts the pre-update software back in use if the operation result is not within a predetermined acceptable range.

A control method according to another aspect of the present invention is for controlling procedure of a controlled apparatus with use of software, and includes determining, when the software is updated, whether a post- update software is to be selected based on an operation result acquired by actually operating the controlled apparatus using the post-update software; and putting the pre-update software back in use if the operation result is not within a predetermined acceptable range.

A computer program product according to still another aspect of the present invention causes a computer to perform the control method according to the present invention.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 shows an overall configuration of an analyzing system according to a first embodiment;

FIG. 2 shows an illustration of an update controller shown in FIG. 1;

FIG. 3 shows an illustration of the update controller shown in FIG. 1;

FIG. 4 shows a flowchart of procedure of software update and software selection in the analyzer shown in FIG. 1;

FIG. 5 shows a flowchart of procedure of software update and software selection in the analyzer shown in FIG. 1; and

FIG. 6 shows configuration of a computer system according to an embodiment.

### DETAILED DESCRIPTION OF THE PREFERRED EMBODIMENTS

Exemplary embodiments of the present invention are described below with reference to accompanying drawings. The present invention, however, is not limited to the embodiments. Same numerals are attached to same elements across the drawings.

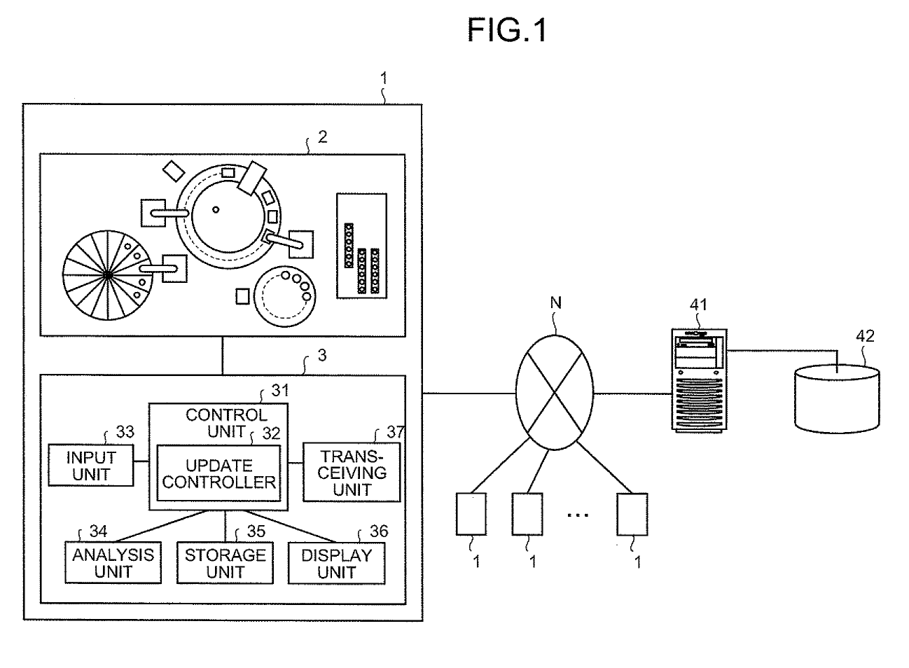

FIG. 1 shows an overall configuration of an analyzing system according to an embodiment. As shown in FIG. 1, the analyzing system according to the embodiment includes plural analyzing apparatuses 1, and a management server 41 which is connected with each of the analyzing apparatuses 1 via a network N to manage each of the analyzing apparatuses 1. The management server 41 includes a database 42 which stores therein various information.

The analyzing apparatus 1 analyzes components of a sample such as a specimen biochemically or immunologically. The analyzing apparatus 1 includes a measuring system 2 which optically measures reaction caused in a reaction vessel, a control system 3 which controls driving of the measuring system 2, and analyzes a result of the measurement performed by the measuring system 2.

The measuring system 2 sequentially dispenses a reagent and a sample such as a specimen into the reaction vessel transported thereinto, stirs the reagent and the sample, and then optically measures a reaction liquid in which the specimen and the reagent are reacted. After the reaction liquid is optically measured, the reaction vessel may be disposed as it is, or cleaned to be re-used for another analysis on a specimen.

The control system 3 is realized by one or more computer systems, and is connected with the measuring system 2 which optically measures the reaction in the reaction vessel. The control system 3 uses various software to control the operation of the measuring system 2 and analyzes the measurement result in the measuring system 2. The control system 3 includes a control unit 31, an input unit 33, an analysis unit 34, a storage unit 35, a display unit 36, and a transceiving unit 37.

The control unit 31 is realized by a CPU or the like which has a control function. The control unit 31 controls processes and operations of each component of the analyzer 1. The control unit 31 performs a predetermined control function of input and output of information which is input and output among each of the components, and performs a predetermined information process on the information. The control unit 31 includes an update controller 32.

The input unit 33 is realized by a keyboard for inputting various information, and a mouse for selecting a certain position on display screen of the display unit 36. The input unit 33 acquires various information required for the analysis of the specimen, instruction information of the analysis operation, and the like from an outside. The analysis unit 34 performs a constituent analysis and the like on a sample based on the measurement result acquired from the measuring system 2. The storage unit 35 includes a hard disk which electromagnetically stores information, and a memory which loads and electrically stores therein, when the analyzer 1 performs a process, various software for the process. The storage unit 35 stores therein various information such as the analysis result of the specimen. The storage unit 35 may include a secondary storage apparatus which can read out information stored in an information medium such as a CD-ROM, a DVD-ROM, and a PC card. The display unit 36 is realized by a display and the like. The display unit 36 displays thereon the various information including the analysis result of the specimen. The transceiving unit 37 has a function as interface for transceiving information in a predetermined format via the network N.

The control unit 31 reads out the software stored in the memory of the storage unit 35 to control the analyzer 1. The update controller 32 is connected with the management server 41 via the transceiving unit 37 and the network N. The update controller 32 downloads update software and information which are needed for updating software, and performs update of the software instructed to be updated by the management server 41.

When the software is updated, the update controller 32 determined whether the post-update software is to be used based on a result of actual operation of the analyzer 1 using the post-update software. The update controller 32 determines whether the post-update software is to be used based on a result as to whether an analysis result of a reference specimen, which leads to a known result, by the analyzer 1 using the post-update software is identical with the known result. In other words, the update controller 32 determines whether the post-update software or the pre-update software is to be selected based on a result of validation as to whether the analysis result of the reference specimen using the post-update software is identical with the known result. When the analysis result of the reference specimen using the post-update software is not identical with the known result, i.e., when the validation is failed, the update controller 32 puts the pre-update software back in use. In updating the software, the update controller 32 keeps both the unchanged pre-update software and the post-update software, and actually operates the analyzer 1 using the post-update software. In this case, the update controller 32 may keep the pre-update software unpatched and thus unchanged. Further, the update controller 32 may not uninstall the pre-update software, and keeps storing the unchanged pre-update software even after the post-update software is acquired.

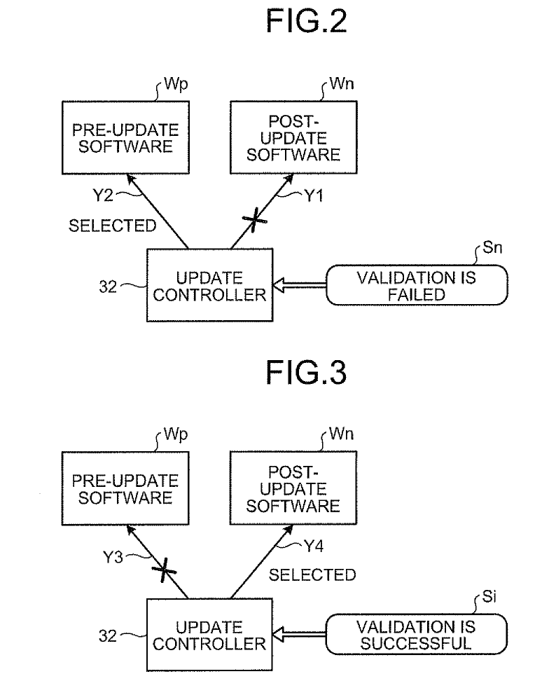

As shown in FIG. 2, when information Sn indicating that the validation is failed is received, the update controller 32 selects pre-update software Wp shown by an arrow Y2 instead of post-update software Wn shown by an arrow Y1. Then, the update controller 32 uninstalls the post-update software Wn. Since the validation is failed, keeping the post-update software makes operations of each of the mechanisms of the analyzer 1 go wrong due to the post-update software, whereby the predetermined analysis accuracy cannot be guaranteed. The update controller 32 selects the pre-update software which guarantees the predetermined analysis accuracy, whereby the analysis accuracy of the analyzer 1 is guaranteed.

On the other hand, as shown in FIG. 3, when information Si indicating that the validation is successful, the update controller 32 selects the post-update software Wn shown by an arrow Y4 instead of the pre-update software shown by an arrow Y3. Since the validation is successful, the predetermined analysis accuracy can be guaranteed with the updated software. The update controller 32 uninstalls the pre-update software Wp.

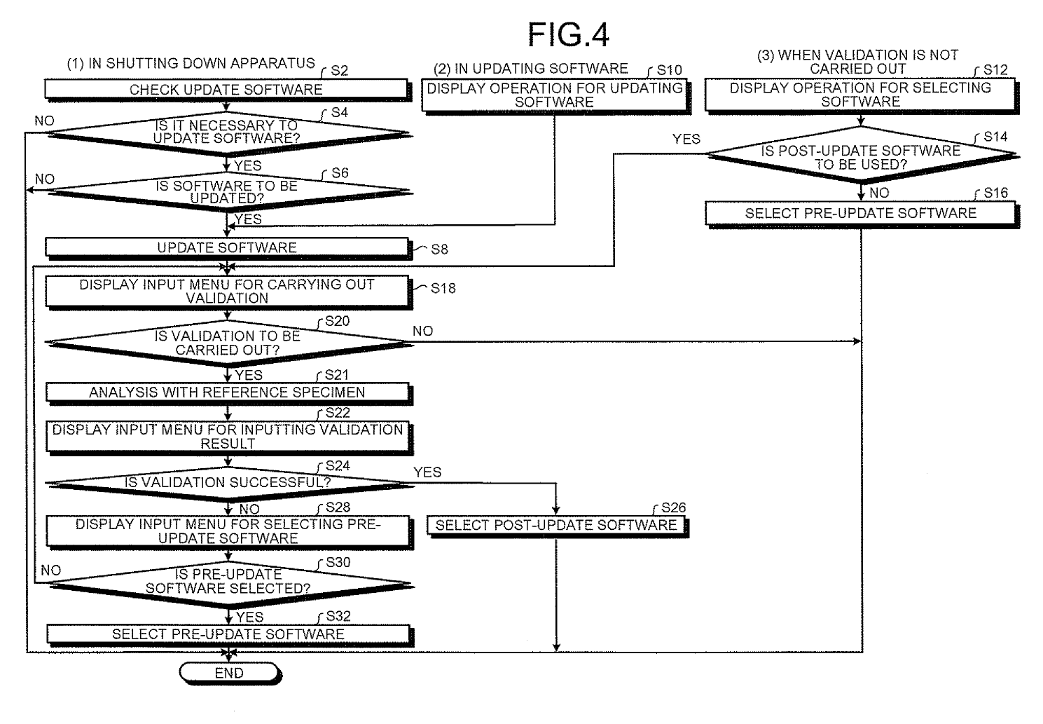

As shown in FIG. 4, procedures of the software update and the software selection in the analyzer 1 are described below. In shutting down the analyzer 1, the update controller 32 sends a request to the management server 41 via the network N to check whether the software update is necessary (Step S2), and the update controller 32 determines whether the software update is necessary based on response from the management server 41 (Step S4). When the update controller 32 determines that the software update is not necessary (Step S4: No), the update controller 32 finishes the process. On the other hand, when the update controller 32 determines that the software update is necessary (Step S4: Yes), the update controller 32 determines whether the software update is to be performed based on the instruction information input from the input unit 33 (Step S6). When the update controller 32 determines that the software update is not to be performed (Step S6: No), the update controller 32 finishes the process. On the other hand, when the update controller 32 determines that the software update is to be performed (Step S6: Yes), the update controller 32 acquires the software and the like needed for the software update from the management server 41 connected therewith via the network N, and updates the software which needs to be updated (Step S8). As described above, the update controller 32 does not uninstall the pre-update software and keeps storing the pre-update software.

In updating the software in the analyzer 1, the display unit 36 displays an operation menu for updating the software (Step S10), and the update controller 32 updates the software which needs to be updated (Step S8).

Further, when the validation is not carried out after the software update, the display unit 36 displays a software-selecting operation menu for selecting the post-update software or the pre-update software (Step S12). The update controller 32 determines whether the post-update software is to be used based on the information input from the input unit 33, that is, the instruction information instructing which software is to be used, the post-update software or the pre-update software (Step S14). When the update controller 32 determines that the post-update software is not to be used (Step S14: No), the update controller 32 selects the pre-update software as the software to be used (Step S16), and finishes the software selecting process.

When the software update process finishes (Step S8), or when the update controller 32 determines that the post-update software is to be used (Step S14: Yes), the update controller proceeds to Step S18, at which the display unit 36 displays an input menu for inputting an instruction as to whether the validation is to be performed or not (Step S18). The input menu includes, for example, one selection field for performing the validation, and another for not performing the validation. The operator selects either the field for performing the validation or the field for not performing the validation via the input unit 33, e.g., the mouse.

The update controller 32 determines whether the information for performing the validation is input from the input unit 33 (Step S20). When the information for not performing the validation is input as a result of the operation by the operator (Step S20: No), the update controller finishes the process.

On the other hand, when the information for performing the validation is input to the update controller 32 (S20: Yes), the operator arranges the reference specimen in the analyzer 1, and instructs the analyzer 1 to perform the predetermined analysis process on the reference specimen. Following the instruction information of the analysis process, the analyzer 1 performs the analysis process on the reference specimen using the post-update software (Step S21), and displays the analysis result of the reference specimen on the display unit 36. Then, the display unit 36 displays thereon the input menu for inputting the validation result (Step S22). The input menu includes, for example, one field for inputting information that the validation is successful, and another for inputting information that the validation is failed. The operator selects either the input field indicating that the validation is successful, or the field indicating that the validation is failed. Then, the update controller 32 determines whether the information indicating that the validation is successful is input from the input unit 33 (Step S24).

When the analysis result of the reference specimen is identical with the known result, i.e., when the validation is successful, the operator selects the input field indicating that the validation is successful via the mouse. As a result, the update controller 32 receives information indicating that the validation is successful from the input unit 33, and thus determines that the validation is successful (Step S24: Yes). In this case, the update controller 32 selects the post-update software as the software to be used (Step S26), uninstalls the pre-update software, and finishes the software selecting process. Each mechanism of the analyzer 1 can operate normally, and the analyzer 1 can guarantee the predetermined analysis accuracy with the software updated.

On the other hand, when the analysis result of the reference specimen is not identical with the known result, i.e., when the validation is failed, each mechanism of the analyzer 1 goes wrong in performing the operations thereof due to the use of the post-update software, whereby the analyzer 1 cannot guarantee the analysis accuracy. In this case, the operator selects the input field indicating that the validation is failed via the mouse. As a result, the update controller 32 receives the information indicating that the validation is failed from the input unit 33, and thus determines that the validation is failed (Step S24: No). After that, the display unit 36 displays an input menu for selecting the pre-update software (Step S28). The input menu includes one field for selecting the pre-update software, and another for not selecting the pre-update software. Based on the information input from the input unit 33, the update controller 32 determines that the pre-update software is to be selected (Step S30).

When the instruction information indicating that the pre-update software is not to be selected is input to the update controller 32, i.e., when the update controller 32 determines that the pre-update software is not to be selected (Step S30: No), the update controller 32 proceeds to Step S18. The display unit 36 displays the input menu for inputting information as to whether the validation is to be performed or not (Step S18). The update controller 32 determines whether the validation is to be performed again (Step S20). When the update controller 32 determines that the validation is to be performed again (Step S20), the update controller 32 performs the analysis process on the reference specimen to perform the validation again (Step S21).

On the other hand, when the instruction information indicating that the pre-update software is to be selected is input to the update controller 32, i.e., when the update controller 32 determines that the pre-update software is to be selected (Step S32), the update controller 32 uninstalls the post-update software, and finishes the software selecting process. When the post-update software is used, each mechanism of the analyzer 1 goes wrong in performing the operations thereof due to the use of the post-update software, whereby the analyzer 1 cannot guarantee the predetermined analysis accuracy. Thus, the update controller 32 selects the pre-update software, with which the predetermined analysis accuracy is guaranteed.

As described, when the software is updated, the analyzer 1 according to the embodiment performs the actual analysis process on the reference specimen using the post-update software. When the analysis result using the post-update software is not identical with the known result of the reference specimen, i.e., when the validation is failed, the analyzer 1 selects the pre-update software instead of the post-update software, and uninstalls the post-update software. In other words, in the analyzer 1, when the validation is failed and thus it is preferable to use the pre-update software to guarantee the predetermined analysis accuracy, the analyzer 1 automatically set the pre-update software as the software to be used, and uninstalls the post-update software. Thus, even if the validation is failed, the analyzer 1 can put the pre-update software back in use immediately and easily, whereby the troublesome operations are avoided.

Further, when the validation is failed, the analyzer 1 can put the pre-update software back in use immediately and easily. As a result, the downtime of the analyzer can be shortened, and the analysis process is less inhibited by the software update process.

Further, when the validation is failed, the analyzer 1 automatically uninstalls the post-update software, whereby the serviceperson does not have to stay around the analyzer 1 to update the software. As a result, the analyzer 1 can cut down maintenance cost of the analyzer 1 such as travel expenses of the serviceperson.

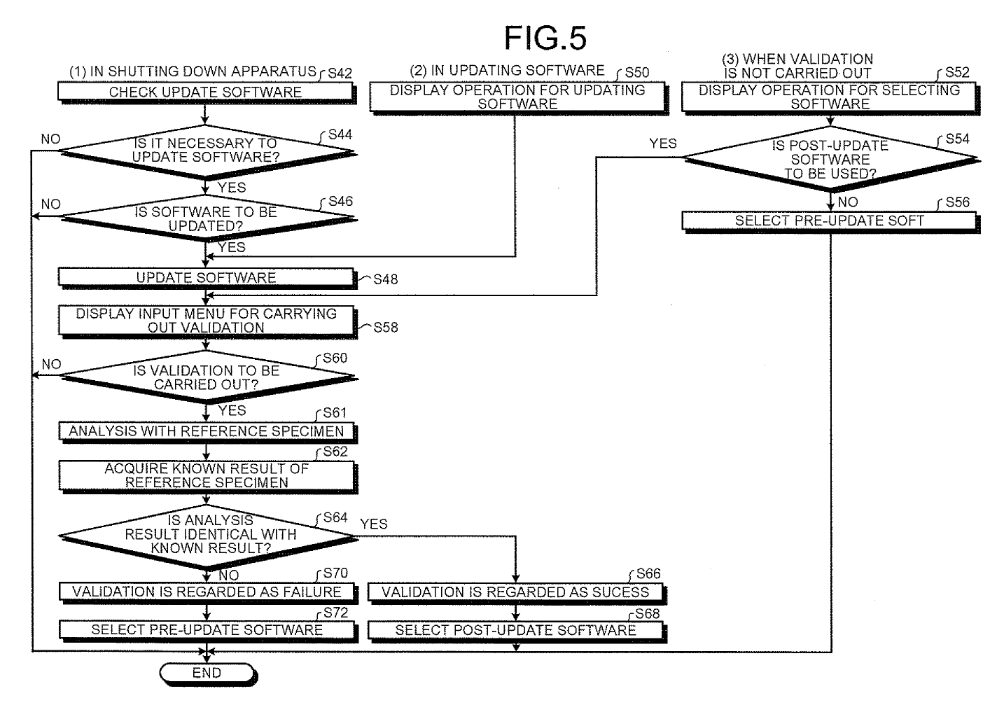

In the first embodiment, the update controller 32 acquires the result of the validation by receiving the information indicating that the validation is successful or failed to thereby select the software. The first embodiment, however, does not limit the application of the update controller. As shown in FIG. 5, the update controller 32 may compare the actual analysis result of the reference specimen with the known result of the reference specimen to determine whether the validation is successful or failed. FIG. 5 shows a flowchart of another procedure of software update and software selection in the analyzer. As shown in FIG. 5, similarly to the Steps S2 to S20 in FIG. 4, the analyzer performs processes of sending a request to check the update software (Step S42), determining whether the software update is needed (Step S44), checking whether there is the software update (Step S46), updating the software (Step S48), displaying the software update operation (Step S50), displaying the software selection operation (Step S52), determining whether the post-update software is to be used (Step 54), selecting the pre-update software (Step S56), displaying the input menu for performing the validation (Step S58), and determining whether the validation is to be performed (Step S60). When the update controller 32 determines that the information indicating that the validation is to be performed is input (Step S60: Yes), the analyzer 1 performs the analysis process of the reference specimen in which the post-update software is actually used (Step S61), and outputs the analysis result.

The update controller 32 acquires the known result of the reference specimen which has been analyzed at Step S61 (Step S62). The known result may be stored in the storage unit 35, or input from an outside via the input unit 33. The update controller 32 determines whether the actual analysis result obtained by actually using the post-update software is identical with the known result (Step S64). When the update controller 32 determines that the actual analysis result obtained by using the post-update software is identical with the obtained known result of the reference specimen (Step S64: Yes), the update controller 32 determines that the validation is successful (Step S66). Then, the update controller 32 performs the processes similar to Step S26 shown in FIG. 3 to thereby select the post-update software (Step S68). On the other hand, when the update controller 32 determines that the actual analysis result using the post-update software is not identical with the obtained known result of the reference specimen (Step S64: No), the update controller 32 determines that the validation is failed (Step S70). Then, the update controller performs processes similar to Step S32 shown in FIG. 3 to thereby select the pre-update software (Step S72), and uninstalls the post-update software.

As shown in FIG. 5, the actual analysis result of the reference specimen using the post-update software is compared with the known result of the reference specimen to determine whether the validation is successful or failed, and automatically selects the preferable software, whereby the software selection can be performed immediately and easily.

In the present embodiment, it is determined whether the validation is successful or failed based on whether the actual analysis result of the reference specimen is exactly identical with the known result. Alternatively, the determining process as to whether the validation is successful or failed may be based on whether the actual analysis result of the reference specimen is within the predetermined acceptable range which guarantees the analysis accuracy required for the analyzer 1.

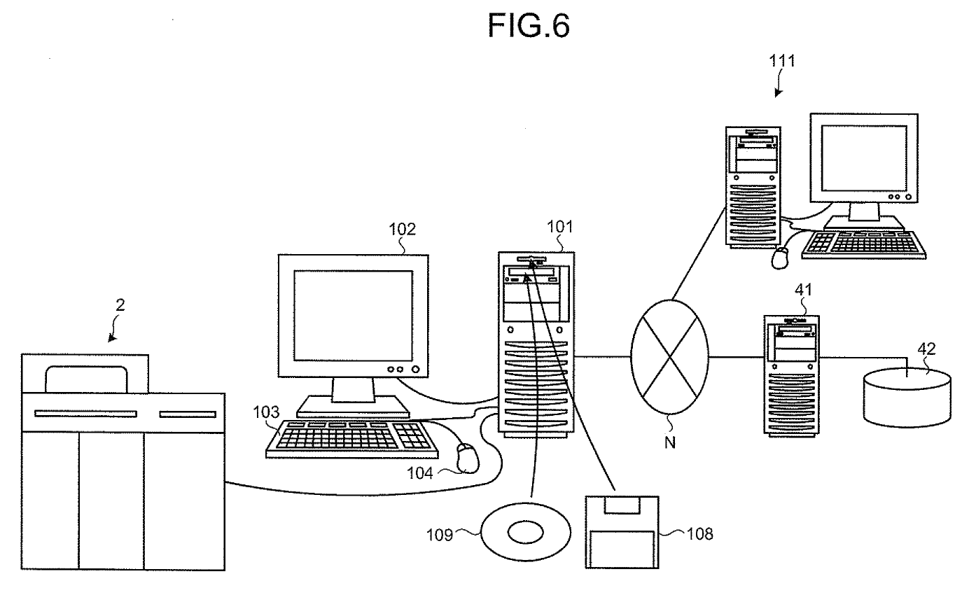

In the present embodiment, the information and the like required for the software update are acquired from the management server 41 via the network N. Not limited to this, the information and the like required for the software update may be acquired from a portable physical medium such as a flexible disk (FD) 108, a CD-ROM 109, an MO disk, a DVD disk, a magnet-optical disk, and an IC card as shown in FIG. 6. Further, the information and the like required for the software update may be acquired from another computer system 111 connected therewith via the network N. The main body 101 shown in FIG. 6 corresponds to the control unit 31, the input unit 33, the analysis unit 34, the storage unit 35, and the transceiving unit 37 in the control system 3. A display 102 corresponds to the display unit 36. A keyboard 103 and a mouse 104 correspond to the input unit 33.

The analyzer according to the embodiment above may be realized by using a computer system shown in FIG. 6 such as a personal computer and a workstation which executes a prepared program. The computer system reads out and executes programs stored in a certain storage medium to perform the process of the analyzer 1. The certain storage medium may be any storage medium, that is, may be “the portable physical medium” such as the flexible disk (FD) 108, the CD-ROM 109, the MO disk, the DVD disk, the magnet-optical disk, and the IC card, and further, may be “a transmission medium” such as a hard disk drive (HDD) stored inside or outside the computer system which can store therein programs in a short time to transmit programs. The computer system realizes the operation of the analyzer 1 by acquiring the program from the management server 41 which is connected therewith via the network N, and another computer system 111, and executing the acquired program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A control apparatus for controlling procedure of a controlled apparatus, comprising:
an update controller that determines, when the software is updated, whether a post-update software is to be selected based on an actual operation result of operating the controlled apparatus using the post-update software, the update controller putting the pre-update software back in use if the operation result is not within a predetermined acceptable range.

2. The control apparatus according to claim 1, wherein
the update controller actually operates the controlled apparatus using the post-update software while storing both the post-update software and the unchanged pre-update software.

3. The control apparatus according to claim 2, wherein
the update controller does not patch the pre-update software and stores the unchanged pre-update software.

4. The control apparatus according to claim 2, wherein
the update controller does not uninstall the pre-update software, and stores the unchanged pre-update software even after the post-update software is acquired.

5. The control apparatus according to claim 1, wherein
the update controller uninstalls the post-update software when the operation result is not within the predetermined acceptable range, and selects the pre-update software as the software to be used.

6. The control apparatus according to claim 1, wherein
the control apparatus controls an analyzer which analyzes a sample,
the update controller determines whether the post-update software is to be selected based on whether an analysis result acquired by analyzing a reference specimen which produces a known result with use of the post-update software is identical with the known result.

7. A control method for controlling procedure of a controlled apparatus with use of software, comprising:
determining, when the software is updated, whether a post-update software is to be selected based on an operation result acquired by actually operating the controlled apparatus using the post-update software; and
putting the pre-update software back in use if the operation result is not within a predetermined acceptable range.

8. A computer program product having a computer readable medium including programmed instructions for controlling procedure of a controlled apparatus with use of software, wherein the instructions, when executed by a computer, cause the computer to perform:
determining, when the software is updated, whether a post-update software is to be selected based on an operation result acquired by actually operating the controlled apparatus using the post-update software; and
putting the pre-update software back in use if the operation result is not within a predetermined acceptable range.
